(19) United States
(12) Patent Application Publication
(10) Pub. No.: US 2019/0116354 A1
(43) Pub. Date: Apr. 18, 2019

(54) CAMERA CALIBRATION

(71) Applicant: INTEL CORPORATION, Santa Clara, CA (US)

(72) Inventors: Shaojun Yao, Shangai (CN); Caihong Ma, Shanghai (CN)

(73) Assignee: INTEL CORPORATION, Santa Clara, CA (US)

(21) Appl. No.: 16/116,495

(22) Filed: Aug. 29, 2018

(30) Foreign Application Priority Data
Oct. 12, 2017 (CN) PCT/CN2017/105832

(51) Int. Cl. H04N 13/246; G06T 7/73; G06K 9/46

(52) U.S. Cl. CPC H04N 13/246; G06T 2207/10028; G06K 9/46; G06T 7/75

(57) ABSTRACT

In some examples, a camera calibration method for calibrating a plurality of cameras includes determining a relationship between each camera and a unique coordinate system. The calibration method also includes determining a positional relationship between all of the plurality of cameras based on the relationships between each of the cameras and the unique coordinate system.

### TECHNICAL FIELD

This disclosure relates generally to camera calibration.

### BACKGROUND

Camera calibration is an important aspect of computer vision (CV). Camera calibration parameters can be used to provide a relationship between cameras, and can be used in computer vision implementations such as virtual view rendering and generalized iterative closest point (GICP), for example. Camera calibration techniques based on RGB (red green blue) images can become difficult for camera systems including cameras with large baselines (distances between camera lenses) and rotations between cameras.

### BRIEF DESCRIPTION OF THE DRAWINGS

The following detailed description may be better understood by referencing the accompanying drawings, which contain specific examples of numerous features of the disclosed subject matter.

FIG. 1 illustrates a camera system;

FIG. 2 illustrates a three dimensional object;

FIG. 3 illustrates a transparent view of a three dimensional object;

FIG. 4 illustrates a portion of a three dimensional object;

FIG. 5 illustrates a portion of a three dimensional object;

FIG. 6 illustrates a portion of a three dimensional object;

FIG. 7 illustrates a portion of a three dimensional object;

FIG. 8 illustrates camera calibration;

FIG. 9 illustrates camera calibration;

FIG. 10 illustrates camera calibration;

FIG. 11 illustrates a computing device;

FIG. 12 illustrates one or more processor and one or more tangible, non-transitory computer readable media;

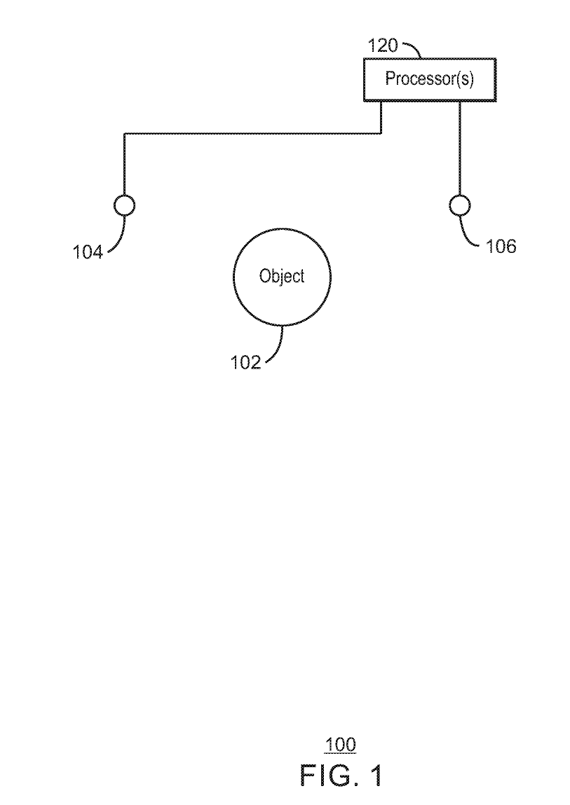

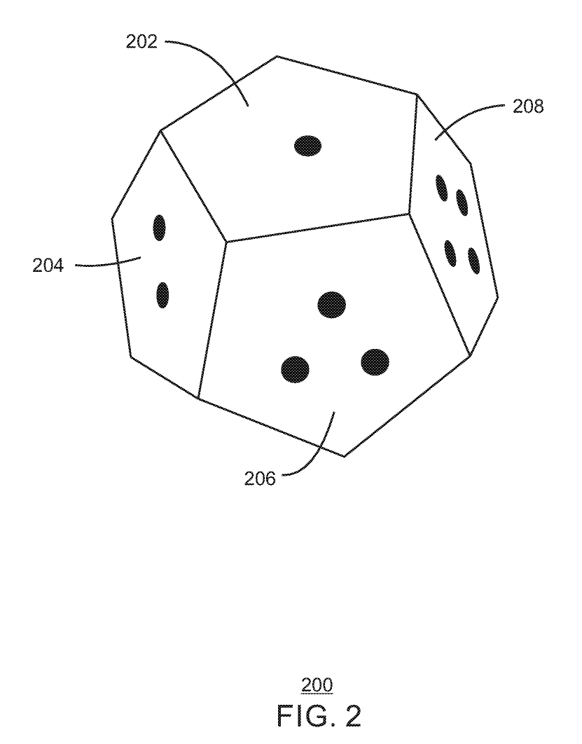

In some cases, the same numbers may be used throughout the disclosure and the figures to reference like components and features. In some cases, numbers in the 100 series may refer to features originally found in FIG. 1; numbers in the 200 series may refer to features originally found in FIG. 2; and so on.

### DESCRIPTION OF SOME EMBODIMENTS

Some embodiments relate to camera calibration. Some embodiments relate to calibration of camera systems. Some embodiments relate to calibration of camera systems with large baselines (distances between camera lenses) and rotations between cameras. Some embodiments relate to RGBD (red green blue depth) cameras and/or camera systems. RGBD cameras can provide depth information by providing points in space using three dimensional (3D) coordinates.

In some embodiments, a three dimensional object may be used to help implement camera calibration. In some embodiments, a symmetrical three dimensional object may be used to help implement camera calibration. In some embodiments, depth cameras are used for calibration. For example, in some embodiments RBGD (red green blue depth) cameras are used. In some embodiments, depth cameras are used that provide depth information. In some embodiments, depth information from one or more depth cameras may be used to provide three dimensional coordinates for points in space being imaged. In some embodiments, calibration of cameras with large rotations and baselines can be calibrated using the depth information from the depth cameras.

In some embodiments, camera calibration can be implemented in a system with any number of cameras. In some embodiments, for each camera in the system, a relationship is determined between that camera and a unique coordinate system. The unique coordinate system can be, for example, a standard coordinate system such as a main coordinate system defined in advance based on a three dimensional model (and/or relative to a three dimensional object). Once such a relationship has been determined for each of the cameras in the system, a positional relationship between all of the cameras in the system can be determined based on the relationships between each of the cameras and the unique coordinate system.

FIG. 1 illustrates a camera system 100. Although FIG. 1 illustrates camera system 100 in two dimensions, system 100 includes a three dimensional object 102, two cameras 104 and 106, and one or more processors 120. In some embodiments, one or more processors 120 can be one or more controllers. In some embodiments, object 102 is a symmetrical three dimensional object. In some embodiments, camera 104 and/or 106 can be attached to a tripod. Cameras 104 and 106 can each include a lens and can each capture an image including all of object 102, or a portion of object 102. Image data from cameras 104 and 106 can be provided to the processor(s) 120.

In some embodiments, cameras 104 and 106 can be RGB cameras. In some embodiments, cameras 104 and 106 can be depth cameras. In some embodiments, cameras 104 and 106 can be RGB-D cameras. In some embodiments, system 100 includes a large baseline between cameras 104 and 106 (for example, a large distance between lenses of cameras 104 and 106). In some embodiments, system 100 includes a large rotation between cameras 104 and 106. For example, in some embodiments, a rotation angle between camera 104 and 106 relative to object 102 is about 150 degrees.

In some embodiments, processor(s) 120 can include a corresponding processor for each of cameras 104 and 106 rather than one processor coupled to both cameras. In some embodiments, processor(s) 120 can include one processor receiving image data from both cameras 104 and 106. In some embodiments, processor(s) 120 can perform camera calibration on the cameras 104 and 106. In some embodiments, processor(s) 120 can be included in a computing system or computing device. In some embodiments, processor(s) 120 can each be a computing system or computing device. In some embodiments, processor(s) 120 can be included in more than one computing system (or computing device).

As discussed above, system 100 is illustrated in FIG. 1 in a two dimensional view, with object 102, cameras 104 and 106, and processor(s) 120 in a common plane. However, it is noted that system 100 is typically in three dimensions. In some embodiments, the elements of FIG. 1 need not be in the same plane. For example, cameras 104 and 106 can be in one or more higher plane than object 102, with fields of view of the cameras looking down toward object 102, and/or one or more lower plane than object 102, with fields of view looking up at object 102, etc. Additionally, although the two dimensional view of system 100 illustrates object 102 as a circle, it is noted that in some embodiments object 102 can be any three dimensional object. In some embodiments, object 102 can be a polyhedron. In some embodiments, object 102 can be a dodecahedron.

Although two cameras 104 and 106 are illustrated in FIG. 1, it is noted that system 100 can include any number of cameras in some embodiments.

FIG. 2 illustrates a three dimensional object 200. In some embodiments, object 200 is a symmetrical three dimensional object. In some embodiments, object 200 can be used as object 102. In some embodiments, object 200 can be a polyhedron. In some embodiments, object 200 can be a dodecahedron. Although all twelve sides of object 200 are not illustrated in FIG. 2, it is noted that FIG. 2 illustrates four sides (or faces) 202, 204, 206 and 208 of a dodecahedron. In some embodiments, object 200 can be an object with a number of sides (or faces) with a unique label on each face. For example, in FIG. 2, object 200 includes a first side 202 with one dot, a second side 204 with two dots, a third side 206 with three dots, and a fourth side 208 with four dots. In some embodiments, object 200 can have additional sides that are not illustrated in FIG. 2 (for example, in some embodiments, eight additional sides not illustrated in FIG. 2 with five dots, six dots, seven dots, eight dots, nine dots, ten dots, eleven dots, and twelve dots, respectively).

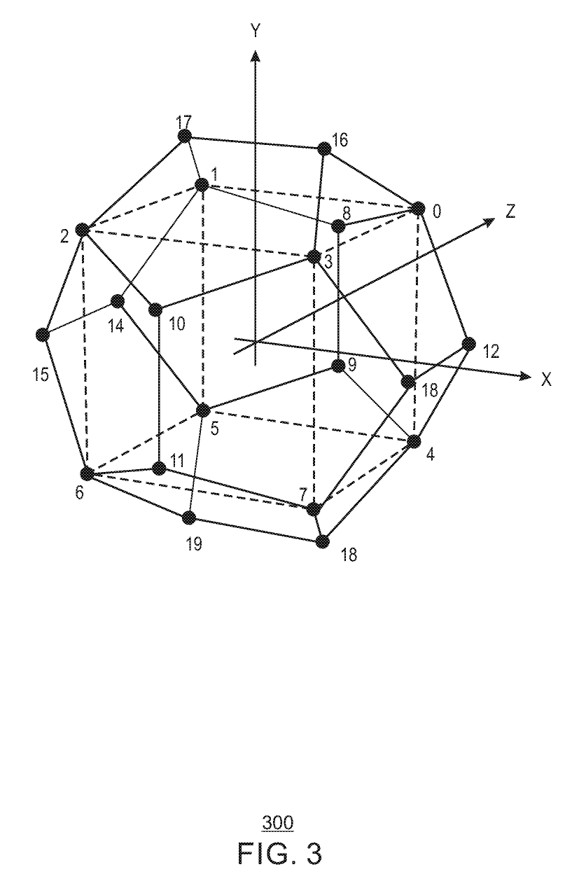

FIG. 3 illustrates a transparent view of a three dimensional object 300. In some embodiments, object 300 is a symmetrical three dimensional object. In some embodiments, object 300 can be used as object 102 and/or 200. In some embodiments, object 300 can be a polyhedron. In some embodiments, object 300 can be a dodecahedron. As illustrated in FIG. 3, object 300 can include twelve side (for example, twelve flat sides) and 20 angular vertex points, labelled as points 0, 1, 2, 3, 4, 5, 6, 7, 8, 9, 10, 11, 12, 13, 14, 15, 16, 17, 18 and 19 in FIG. 3. Each of the vertex points in FIG. 3 has three connected faces and three connected edges. In some embodiments, object 300 can be an object with a number of sides (or faces) with a unique label on each face. For example, in FIG. 3, object 300 can include sides with different numbers of dots on each side (for example, similar to object 200 in FIG. 2). FIG. 3 additionally illustrates a unique standard coordinate system (x, y, z) with three dimensional coordinates defined by the x, y and z axes.

In some embodiments camera calibration can be implemented. In some embodiments, camera calibration is implemented for RGBD camera systems. In some embodiments, camera calibration is implemented for ca era systems with large baselines between camera lenses (and/or with large distances between camera lenses). In some embodiments, camera calibration is implemented for camera systems with large rotations between camera lenses. In some embodiments, a three dimensional object is used as a calibration pattern. In some embodiments, a polyhedron is used as a calibration pattern. In some embodiments, a dodecahedron is used as a calibration pattern. In some embodiments, an object such as object 200 or object 300 is used as a calibration pattern.

In some embodiments, a three dimensional object (for example, a symmetrical three dimensional object, a polyhedron, a dodecahedron, object 200, and/or object 300) is used as a calibration pattern. In some embodiments, the three dimensional object used as the calibration pattern can have a number of surfaces that each have a unique pattern or identifier. For example, the three dimensional object used as the calibration pattern can have a unique label on each of a plurality of faces of the object. In some embodiments, a three dimensional coordinate system is defined for each vertex of the object. Transformation parameters can be calculated between each vertex coordinate system and a unique standard coordinate system. For each camera in the camera system, transformation parameters can be calculated between the camera coordinate system and the vertex coordinate system. For example, for each camera, transformation parameters from the camera coordinate system to the vertex coordinate system, and/or transformation from the vertex coordinate system to the camera coordinate system, can be computed. Then point clouds can be calculated from each camera to a unique standard coordinate system in order to obtain the transformation parameters for each camera. Point clouds can be converted from all cameras to a unique standard coordinate system. That is, in some embodiments, transformation parameters for each camera pair (each camera pairing between the respective camera and the unique standard coordinate system) can be obtained.

Point clouds are a set of data points to some coordinate system. In a three dimensional coordinate system, the points can be defined by three dimensional coordinates. Point clouds can be created by three dimensional devices such as 3D scanners or depth cameras, for example. A large number of points on the surface of an object are measured, and a point cloud data file can be created as a result. The point cloud represents the set of points on the object as measured by the 3D device. Point clouds can refer to a collection of vectors or points that represent a shape. In 3D image rendering, the points by themselves may not be sufficient to provide a visual representation of the shape, since they may represent a single coordinate in space rather than a volume or an association with neighboring points in order to imply a surface of an object. However, the points can be stitched together to form polygons or other surfaces using surface-defining techniques in order to produce a solid render of the shape being represented.

Raw data that is received from a depth camera may not therefore be referred to as a 3D shape, but may be more accurately referred to as data that is a point cloud aligned within a regular grid, for example. Raw depth data may be thought of as a point cloud that allows the data to be welded together into a more accurate 3D representation of a shape. For example, a room may be scanned with one or more scanner and/or one or more depth camera from several different vantage points (or angles), and the point cloud data from each of those vantage points (or angles) can be stitched together by detecting common points from the various vantage points (or angles). This can be accomplished, for example, using the cameras of the system of FIG. 1 from various vantage points.

In some embodiments, 3D model reconstruction of point clouds can be implemented from different 3D camera vantage points. When the point clouds from the different 3D camera vantage points have a limited number of common portions, 3D model reconstruction can still be implemented according to some embodiments. In this manner, the number of different point clouds necessary to perform the reconstruction can be limited to a low number. For example, in some embodiments, even in a situation where cameras provide very little if any overlap between point clouds due to, for example, a large baseline distance and/or rotation between camera vantage points, a low number of point clouds may still be utilized to accurately reconstruct the 3D image. This can be implemented, for example, using a 3D object (for example, a symmetrical 3D object) as the calibration pattern, where the object has unique portions that can be used to help represent the object and calculate calibration and/or transformation parameters. For example, in some embodiments, in a camera system with only two cameras at a large distance from each other and/or at a large rotational angle from each other, accurate calibration can still be implemented.

According to some embodiments, 3D model reconstruction can be used when point clouds from different camera locations (for example, point clouds from different locations of 3D cameras) have limited common portions. In some embodiments, a number of point clouds necessary for reconstruction can be reduced. In some embodiments, assisted cameras necessary in multi-camera applications can be limited or eliminated completely. For example, in some embodiments, only two cameras are needed.

In some embodiments, calibration transformation parameters for each camera pair (or for each camera image to be transformed into unique standard coordinates) can be stored and reused, particularly if the camera location is fixed. In this manner, the transformation parameters can be obtained from the stored location easily and quickly.

In some embodiments, a three dimensional object (for example, a symmetrical three dimensional object, and/or a three dimensional object such as a dodecahedron) can be used (for example, a dodecahedron as illustrated in FIG. 2 and/or FIG. 3). In some embodiments, the three dimensional object has unique labels on each of a number of faces, and can be used as a calibration pattern to be used in calibrating cameras such as 3D cameras. For example, a dodecahedron has a number of vertices (or vertexes) such as 20 different vertices (vertexes). In some embodiments, each vertex has three connected faces and three connected edges. Unit vectors along the connected edges can be defined as [v₁, v₂, v₃] and normal vectors of the faces can be defined as [n₁, n₂, n₃]. A 3D coordinate system centered on the vertex can be defined by taking v as the x axis and n as the z axis, where vϵ[v₁, v₂, v₃] and nϵ[n₁, n₂, n₃]. Since v and n must be orthogonal, each vertex may have six specified coordinate systems. Transformation parameters can be calculated from these vertex coordinate systems to a unique standard coordinate system (x,y,z) according to the geometry structure of the object. In some embodiments, the transformation parameters can be calculated in advance prior to the calibration process of the camera system.

According to some embodiments, a camera calibration process can be implemented for each camera in a camera system. In some embodiments, this process for each camera can include obtaining the point cloud and detecting object faces (for example, detecting dodecahedron faces), selecting a number of adjacent faces with the best quality (for example, three adjacent faces with the best quality), calculating confidence values for coordinate systems of one or more vertex of the object (for example, calculating confidence values for six candidate coordinate systems of one or more vertex), and then obtaining transformation parameters for all cameras to a unique standard coordinate system.

In some embodiments, point clouds (or cloud points) of a calibration pattern can be used to perform camera calibration of a camera system with a plurality of cameras. In some embodiments, a point cloud is obtained and three dimensional surfaces of an object (for example, dodecahedron faces) can be detected. For example, in some embodiments, dodecahedron faces 202, 204, 206 and 208 of dodecahedron 200 of FIG. 2 can be detected based on a camera image view from a camera in a camera system.

In some embodiments, adjacent faces (for example, three adjacent faces) of a calibration object are selected. For example, in some embodiments, adjacent faces with a best quality are selected.

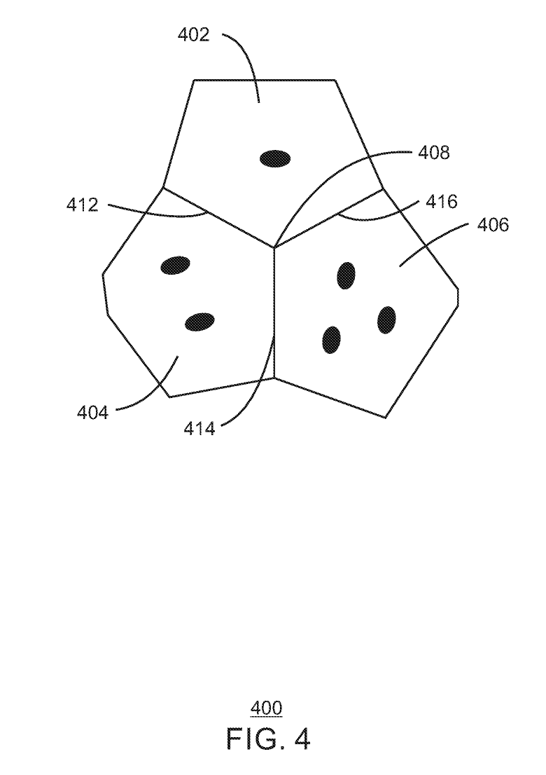

FIG. 4 illustrates an object 400 with three adjacent faces 402, 404, 406. In some embodiments, object 400 is a 3D object. In some embodiments, object 400 is a symmetrical three dimensional object. In some embodiments, FIG. 4 represents a point cloud of object 400. In some embodiments, object 400 is a polyhedron. In some embodiments, object 400 is a dodecahedron. In some embodiments, faces 402, 404 and 406 represent three adjacent faces of a calibration object 400. In some embodiments, faces 402, 404 and 406 illustrate three adjacent faces of highest quality being imaged by a camera in a camera system performing camera calibration, for example.

In some embodiments, a label of each face 402, 404 and 406 is detected. For example, as illustrated in FIG. 4, face 402 has a label with one dot, face 404 has a label with two dots, and face 406 has a label with three dots. In this manner, the label of each face can be detected by counting the number of components (or dots) on the face. Once the faces are identified in this manner, a common vertex 408 of faces 402, 404 and 406, and common edges 412, 414 and 416 can be determined. A vertex label β of the vertex 408 can be obtained based on the identified dodecahedron face 402, 404 and 406 labels.

In some embodiments, confidence values of each of six candidate coordinate systems of a vertex (for example, vertex 408) are calculated. In some embodiments, confidence values of each of six coordinate systems of a plurality of vertices (such as, for example, including vertex 408) are calculated. According to some embodiments, confidence values of each of six coordinate systems of one or more vertex can be calculated based on precision and fundamental vectors (for example, v and n). A most reliable one of the six candidate coordinate systems can be chosen based on the confidence values.

In some embodiments, transformation parameters from a camera coordinate system to a vertex coordinate system can be calculated. For example, transformation parameters may be calculated as follows:

[P₁ P₂ P₃]=M_{c}[P′₁ P′₂ P′₃]

Where M_{c} is a transformation matrix which includes, for example, rotation and translation parameters, [P′₁ P′₂ P′₃] specifies coordinates of three non-collinear points in the camera coordinate system, and [P₁ P₂ P₃] specifies coordinates in the vertex coordinate system.

In some embodiments, for example, P₁ can be set to (0, 0, 0), P₂ can be set to (1, 0, 0), and P₃ can be set to (0, 0, 1), and [P′₁ P′₂ P′₃] can then be computed as:

P′₁=P_{β}

P′₂=P_{β}+v

P′₃=P_{β}+n

Where Pₚ is the coordinate vertex 13, v is the x-axis unit vector of the vertex 13 coordinate system, and n is the z-axis unit vector of the vertex 13 coordinate system. P_{β}, v, and n are defined in the camera coordinate system. As discussed in this disclosure, v can be calculated using edges (for example, using edges 412, 414, 416) of an object (such as a 3D calibration object), and n can be calculated using faces (for example, using faces 402, 404, 406) of an object (such as a 3D calibration object).

In some embodiments, a transformation matrix My can be obtained. Transformation matrix Mᵥ can include transformation parameters from a selected vertex coordinate system to a unique standard coordinate system. A transformation matrix from the camera coordinate system to the unique standard coordinate system may then be obtained by multiplying M_{c} and Mᵥ.

In some embodiments, one or more of the techniques described herein can be repeated for each of a plurality of camera locations. In this manner, transformation parameters from all cameras to a unique standard coordinate system may be obtained and stored (for example, in a memory device and/or storage device, etc.) It is noted that the unique standard coordinate system may be a main coordinate system defined in advance based on a three dimensional (3D) model. Transformation parameters for each camera pair can be obtained according to some embodiments. As used herein, camera pair can refer to a camera used in the calibration process paired with the standard coordinate system.

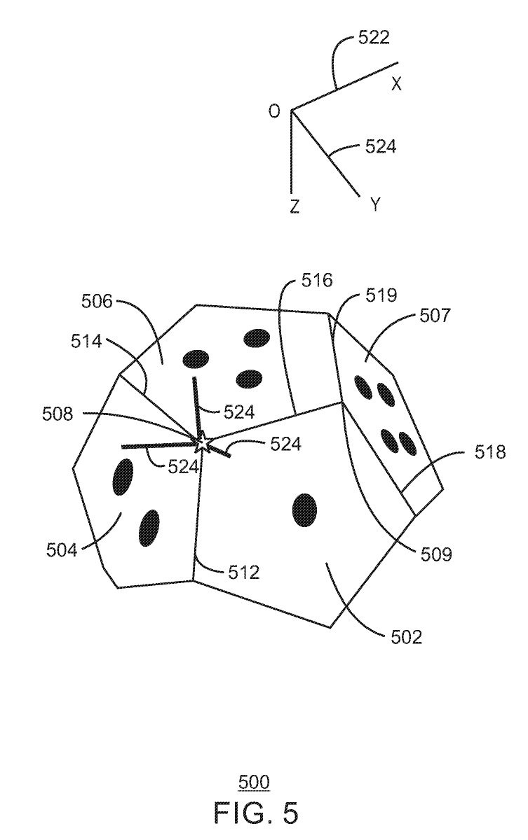

FIG. 5 illustrates an object 500 with four adjacent faces 502, 504, 506, and 507. In some embodiments, the object 500 is a 3D object. In some embodiments, object 500 is a symmetrical three dimensional object. In some embodiments, FIG. 5 represents a point cloud 500 of an object. For example, in some embodiments, FIG. 5 represents an input point cloud 500 of an object. In some embodiments, object 500 is a polyhedron. In some embodiments, object 500 is a dodecahedron. In some embodiments, faces 502, 504, 506, and 507 represent four adjacent faces of a calibration object 500 and/or a point cloud 500. In some embodiments, object and/or point cloud 500 represents a calibration object imaged by one or more cameras in a camera system performing camera calibration, for example.

In some embodiments, a label of each face 502, 504, 506, and 507 can be detected. For example, as illustrated in FIG. 5, face 502 has a label with one dot, face 504 has a label with two dots, face 506 has a label with three dots, and face 507 has a label with four dots. In this manner, the label of each face can be detected by counting the number of components (or dots) on the face. Once the faces are identified in this manner, common vertices 508 and/or 509 and common edges 512, 514, 516, 518, and/or 519 can be determined. A vertex label β of the vertex 508 can be obtained based on the identified dodecahedron face 502, 504 and 506 labels. Similarly, a vertex label of the vertex 509 can be obtained based on the identified dodecahedron face 502, 506 and 507 labels, for example. In FIG. 5, common vertex 508 is illustrated by a star. However, it is noted that vertex 508 is a vertex point similar to, for example, vertex 408 or vertex 509. Common edge vectors 522 (x) represent, for example, common edge vectors of edges 512, 514, and/or 516 in a camera coordinate system, where the origin O is at the top of the object. Face normal vectors 524 (y) represent, for example, normal vectors of faces 502, 504, and/or 506 in a camera coordinate system, where the origin O is at the top of the object 500.

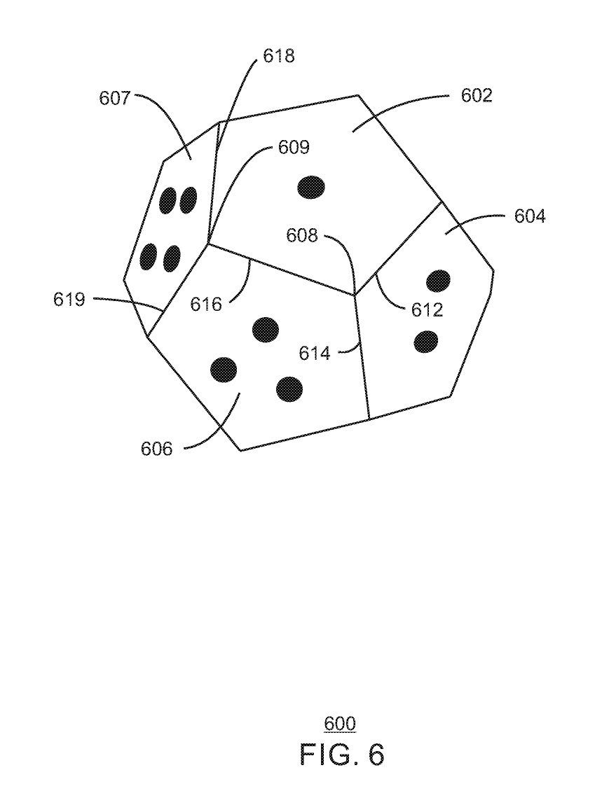

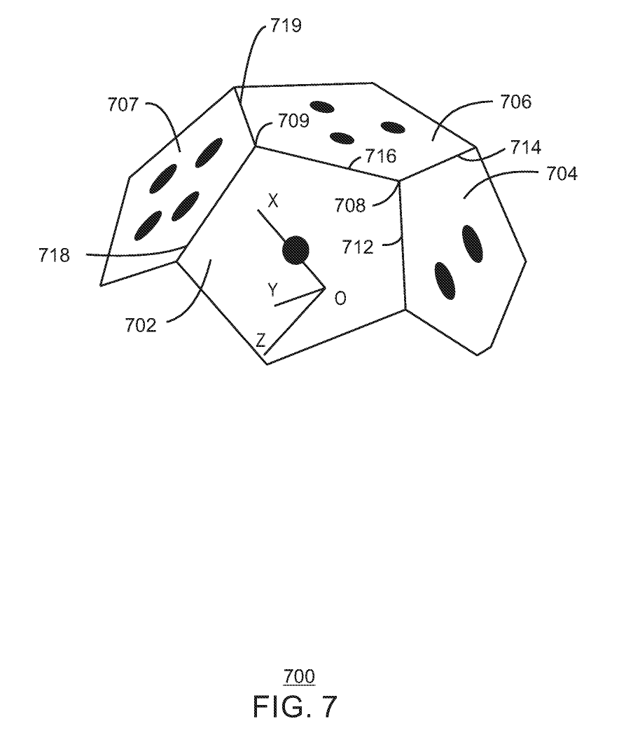

In some embodiments, FIG. 6 and FIG. 7 respectively represent transformed point clouds 600 and 700 from different views in a unique standard coordinate system. For example, in some embodiments, the unique standard coordinate system of FIG. 6 and FIG. 7 is at a center of the object represented by point clouds 600 and/or 700.

FIG. 6 illustrates an object 600 with four adjacent faces 602, 604, 606, and 607. In some embodiments, the object 600 is a 3D object. In some embodiments, object 600 is a symmetrical three dimensional object. In some embodiments, FIG. 6 represents a point cloud 600 of an object. For example, in some embodiments, FIG. 6 represents an input point cloud 600 of an object. In some embodiments, FIG. 6 represents a transformed point cloud from a view in the unique standard coordinate system, where the origin is at the center of the object. In some embodiments, object 600 is a polyhedron. In some embodiments, object 600 is a dodecahedron. In some embodiments, faces 602, 604, 606, and 607 represent four adjacent faces of a calibration object 600 and/or a point cloud 600. In some embodiments, object and/or point cloud 600 represents a calibration object imaged by one or more cameras in a camera system performing camera calibration, for example.

In some embodiments, a label of each face 602, 604, 606, and 607 can be detected. For example, as illustrated in FIG. 6, face 602 has a label with one dot, face 604 has a label with two dots, face 606 has a label with three dots, and face 607 has a label with four dots. In this manner, the label of each face can be detected by counting the number of components (or dots) on the face. Once the faces are identified in this manner, common vertices 608 and/or 609 and common edges 612, 614, 616, 618, and/or 619 can be determined. A vertex label p of the vertex 608 can be obtained based on the identified dodecahedron face 602, 604 and 606 labels. Similarly, a vertex label of the vertex 609 can be obtained based on the identified dodecahedron face 602, 606 and 607 labels, for example.

FIG. 7 illustrates an object 700 with four adjacent faces 702, 704, 706, and 707. In some embodiments, the object 700 is a 3D object. In some embodiments, object 700 is a symmetrical three dimensional object. In some embodiments, FIG. 7 represents a point cloud 700 of an object. For example, in some embodiments, FIG. 7 represents an input point cloud 700 of an object. In some embodiments, FIG. 7 represents a transformed point cloud from a view in the unique standard coordinate system represented by the x, y, and z axes in FIG. 7, where the origin O is at the center of the object. In some embodiments, object 700 is a polyhedron. In some embodiments, object 700 is a dodecahedron. In some embodiments, faces 702, 704, 706, and 707 represent four adjacent faces of a calibration object 700 and/or a point cloud 700. In some embodiments, object and/or point cloud 700 represents a calibration object imaged by one or more cameras in a camera system performing camera calibration, for example.

In some embodiments, a label of each face 702, 704, 706, and 707 can be detected. For example, as illustrated in FIG. 7, face 702 has a label with one dot, face 704 has a label with two dots, face 706 has a label with three dots, and face 707 has a label with four dots. In this manner, the label of each face can be detected by counting the number of components (or dots) on the face. Once the faces are identified in this manner, common vertices 708 and/or 709 and common edges 712, 714, 716, 718, and/or 719 can be determined. A vertex label 13 of the vertex 708 can be obtained based on the identified dodecahedron face 702, 704 and 706 labels. Similarly, a vertex label of the vertex 709 can be obtained based on the identified dodecahedron face 702, 706 and 707 labels, for example.

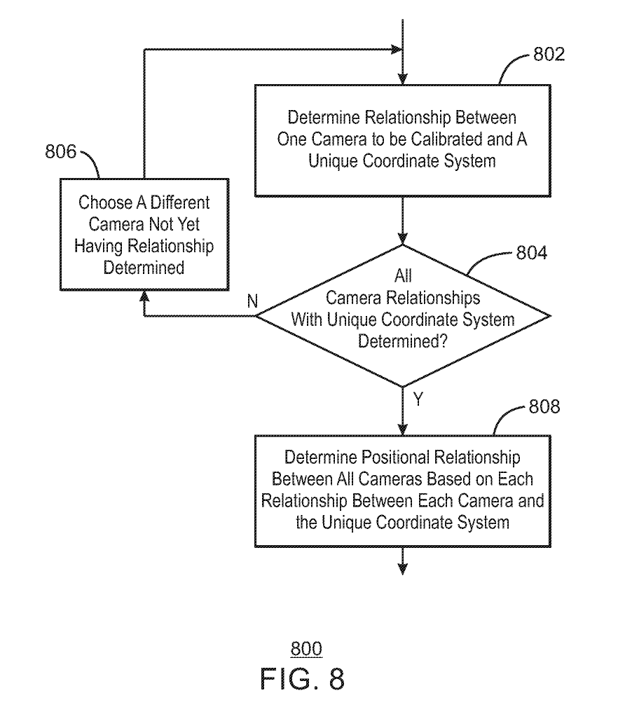

FIG. 8 illustrates camera calibration 800 according to some embodiments. In some embodiments, any of the techniques described herein can be included in camera calibration 800. In some embodiments, at 802 a relationship between one camera (for example, one of a plurality of cameras) to be calibrated and a unique coordinate system is determined. In some embodiments, for example, the unique coordinate system is defined in advance based on a three dimensional model. In some embodiments, for example, the relationship between the camera and the unique coordinate system is determined at 802 in response to an image of a three dimensional calibration object obtained by that camera. In some embodiments, the three dimensional calibration object is a polyhedron with a unique label on each face of the polyhedron, for example. In some embodiments, two or more faces of the polyhedron can be detected using a unique label on two or more faces of the polyhedron. In some embodiments, the polyhedron is a dodecahedron, for example.

At 804, a determination is made as to whether all camera relationships with unique coordinate systems have been determined. That is, at 804 it is determined whether 802 has been performed for all of a plurality of cameras to be calibrated. If all camera relationships with the unique coordinate system have not been determined at 804, then flow moves to 806. At 806, a different one of the plurality of cameras is chosen at 806. That is, a different one of the plurality of cameras to be calibrated for which a determination has not been made at 802 is chosen at 806. Then a relationship between the camera to be calibrated that is chosen at 806 and the unique coordinate system is determined at 802. Flow then continues between 804, 806 and 802 for all of the plurality of cameras to be calibrated. Once it is determined at 804 that all camera relationships with the unique coordinate system have been determined, flow moves to 808. A positional relationship between all of the plurality of cameras to be calibrated is determined at 808 based on each individual relationship between each camera and the unique coordinate system. That is, in some embodiments, a positional relationship is determined at 808 between all cameras based on the relationships determined for each camera at 802.

It is to be understood that the block diagram of FIG. 8 is not intended to indicate that camera calibration is to include all of the components shown in FIG. 8. Rather, camera calibration 800 can include fewer and/or additional components not illustrated in FIG. 8. For example, in some embodiments, camera calibration 800 can include any of the techniques described herein.

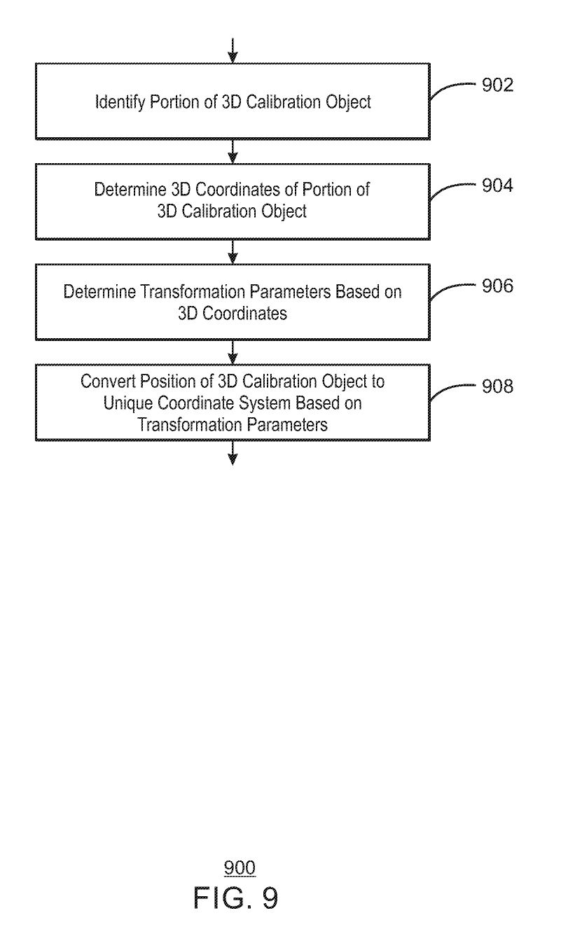

FIG. 9 illustrates camera calibration 900 according to some embodiments. In some embodiments, any of the techniques described herein can be included in camera calibration 900. In some embodiments, all or a portion of camera calibration 900 can be included in box 802 of camera calibration 800 of FIG. 8. That is, in some embodiments, all or a portion of camera calibration 900 can be included in determining a relationship between one or more of a plurality of cameras to be calibrated and a unique coordinate system. In some embodiments, camera calibration 900 can be repeated for each of a plurality of cameras to be calibrated.

At 902 a portion of a three dimensional calibration object is identified in response to a camera image from the camera. At 904, three dimensional coordinates in a coordinate system of a portion of the three dimensional calibration object are determined. The coordinate system of the portion of the three dimensional calibration object is oriented based on the identified portion of the three dimensional object, for example. At 906, transformation parameters are determined based on the three dimensional coordinates (for example, in the coordinate system of the portion of the three dimensional calibration object). At 908, a position of the three dimensional calibration object is converted to the unique coordinate system based on the transformation parameters.

In some embodiments, camera calibration 900 includes repeating one or more of the camera calibration techniques for each camera location in a camera system with a plurality of cameras. For example, in some embodiments, some or all of the functionality of box 902, 904, 906, and/or 908 can be repeated for each camera location in a camera system.

It is to be understood that the block diagram of FIG. 9 is not intended to indicate that camera calibration is to include all of the components shown in FIG. 9. Rather, camera calibration 900 can include fewer and/or additional components not illustrated in FIG. 9. For example, in some embodiments, camera calibration 900 can include any of the techniques described herein.

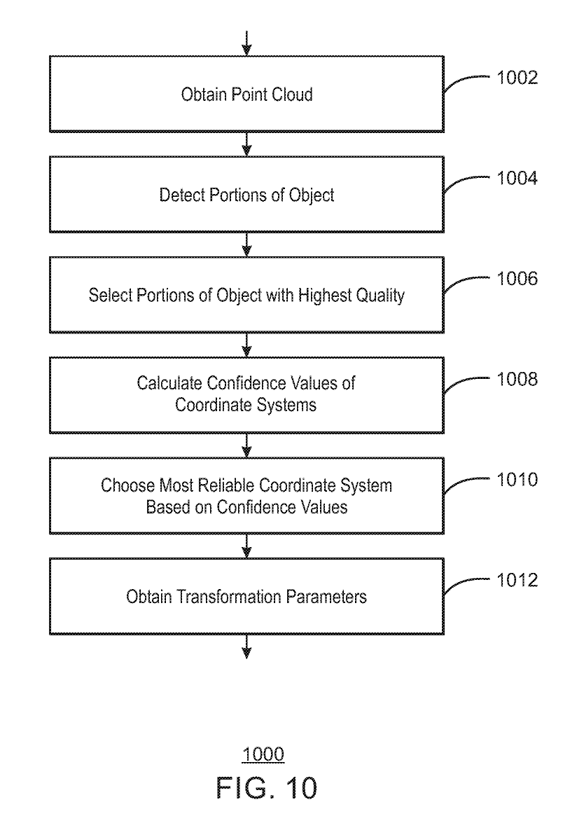

FIG. 10 illustrates camera calibration 1000 according to some embodiments. In some embodiments, any of the techniques described herein can be included in camera calibration 1000. In some embodiments, all or a portion of camera calibration 1000 can be included in box 802 of camera calibration 800 of FIG. 8. That is, in some embodiments, all or a portion of camera calibration 1000 can be included in determining a relationship between one or more of a plurality of cameras to be calibrated and a unique coordinate system. In some embodiments, camera calibration 1000 can be repeated for each of a plurality of cameras to be calibrated.

In some embodiments, a point cloud for a camera in a camera system undergoing camera calibration is obtained at 1002. Portions (for example, surfaces or faces) of a calibration object (for example, a three dimensional object, a symmetrical three dimensional object, a polyhedron, and/or a dodecahedron, etc.) are detected at 1004. A number of portions (for example, three faces or surfaces) of the object with a highest quality and/or adjacent to one another are selected at 1006. For example, in some embodiments, one or more common vertex and/or common edges may be determined. Confidence values of coordinate systems are calculated at 1008. For example, in some embodiments, confidence values for a plurality of coordinate systems of a vertex point can be calculated. A most reliable coordinate system is determined (for example, based on the confidence values) at 1010. Transformation parameters are obtained at 1012. For example, in some embodiments, one or more transformation matrix can be used to obtain transformation parameters.

In some embodiments, camera calibration 1000 includes repeating one or more of the camera calibration techniques for each camera location in a camera system with a plurality of cameras. For example, in some embodiments, some or all of the functionality of box 1002, 1004, 1006, 1008, 1010, and/or 1012 can be repeated for each camera location in a camera system.

In some embodiments, transformation parameters to a unique standard coordinate system from each of the cameras can be obtained. In some embodiments, transformation parameters for each camera pair may be obtained. That is, transformation parameters for each camera relative to the unique standard coordinate system may be obtained. In some embodiments, obtained transformation parameters may be stored (for example, in a memory device or a storage device).

It is to be understood that the block diagram of FIG. 10 is not intended to indicate that camera calibration is to include all of the components shown in FIG. 10. Rather, camera calibration 1000 can include fewer and/or additional components not illustrated in FIG. 10. For example, in some embodiments, camera calibration 1000 can include any of the techniques described herein.

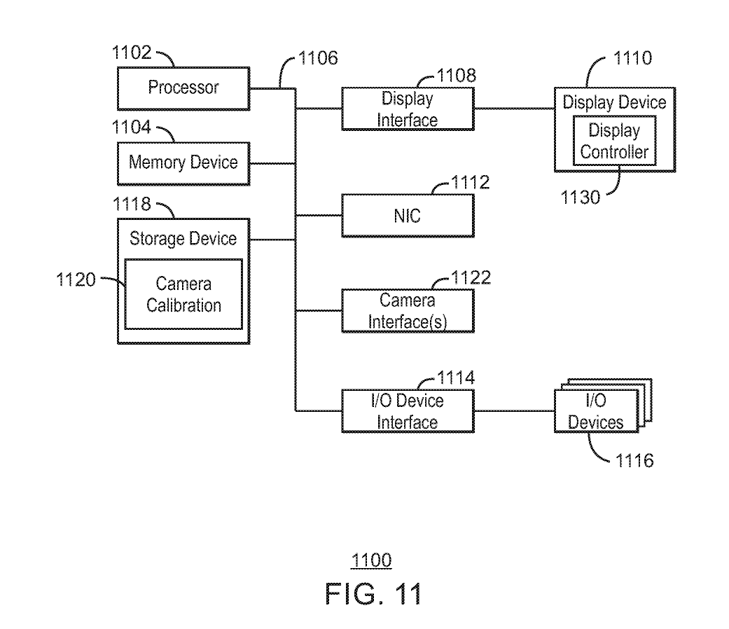

FIG. 11 is a block diagram of an example of a computing device 1100 (and/or a computing system 1100). In some embodiments, device and/or system 1100 can be the computing system 420 illustrated in and described in reference to FIG. 4. In some embodiments, device and/or system 1100 can implement any of the techniques described herein. In some embodiments, computing device and/or system 1100 can implement camera calibration, either alone, or in combination with other devices or systems, according to some embodiments. For example, any of the features illustrated in and/or described in reference to any of the figures and/or discussed in this disclosure can be included within and/or implemented by computing device/system 1100.

The computing device 1100 may be, for example, a mobile device, phone, laptop computer, notebook, tablet, all in one, 2 in 1, and/or desktop computer, etc., among others. The computing device 1100 may include a processor 1102 that is adapted to execute stored instructions, as well as a memory device 1104 (and/or storage device 1104) that stores instructions that are executable by the processor 1102. The processor 1102 can be a single core processor, a multi-core processor, a computing cluster, or any number of other configurations. For example, processor 1102 can be an Intel® processor such as an Intel® Celeron, Pentium, Core, Core i3, Core i5, or Core i7 processor. In some embodiments, processor 1102 can be an Intel® x86 based processor. In some embodiments, device/system 1100 and/or processor 1102 can include (or can be used as) processor 120, for example. In some embodiments, processor 1102 can be a processor or a controller

In some embodiments, processor 1102 can be an ARM based processor. The memory device 1104 can be a memory device and/or a storage device, and can include volatile storage, non-volatile storage, random access memory, read only memory, flash memory, and/or any other suitable memory and/or storage systems. In some embodiments, memory device 1104 and/or storage device 1118 can store instructions for camera calibration according to some embodiments and/or as described herein. In some embodiments, memory device 1104 and/or storage device 1118 can store transformation parameters according to some embodiments and/or as described herein. The instructions that are executed by the processor 1102 may also be used to implement features described in this specification, including any camera calibration techniques, for example. For example, in some embodiments, any of the techniques described in this specification can be implemented entirely or partially within the processor 1102.

The processor 1102 may also be linked through a system interconnect 1106 (e.g., PCI®, PCI-Express®, NuBus, etc.) to a display interface 1108 adapted to connect the computing device 1100 to a display device 1110. In some embodiments, display device 1110 can include any display screen. The display device 1110 may include a display screen that is a built-in component of the computing device 1100. The display device 1110 may also include a computer monitor, television, or projector, among others, that is externally connected to the computing device 1100. The display device 1110 can include liquid crystal display (LCD) or light emitting diode (LED) technologies, for example.

In some embodiments, the display interface 1108 can include any suitable graphics processing unit, transmitter, port, physical interconnect, and the like. In some examples, the display interface 1108 can implement any suitable protocol for transmitting data to the display device 1110. For example, the display interface 1108 can transmit data using a high-definition multimedia interface (HDMI) protocol, a DisplayPort protocol, or some other protocol or communication link, and the like

In some embodiments, display device 1110 includes a display controller 1130. In some embodiments, the display controller 1130 can provide control signals within and/or to the display device 1110. In some embodiments, all or portions of the display controller 1130 can be included in the display interface 1108 (and/or instead of or in addition to being included in the display device 1110).

In addition, a network interface controller (also referred to herein as a NIC) 1112 may be adapted to connect the computing device 1100 through the system interconnect 1106 to a network (not depicted). The network (not depicted) may be a wireless network, a wired network, cellular network, a radio network, a wide area network (WAN), a local area network (LAN), a global position satellite (GPS) network, and/or the Internet, among others.

The processor 1102 may be connected through system interconnect 1106 to an input/output (I/O) device interface 1114 adapted to connect the computing host device 1100 to one or more I/O devices 1116. The I/O devices 1116 may include, for example, a keyboard and/or a pointing device, where the pointing device may include a touchpad or a touchscreen, among others. The I/O devices 1116 may be built-in components of the computing device 1100, or may be devices that are externally connected to the computing device 1100.

In some embodiments, computing device (system) 1100 can include one or more camera interfaces 1122. In some embodiments, one or more cameras can be coupled to the device (system) 1100 via the camera interface(s) 1122. For example, in some embodiments, device/system 1100 can be coupled to one or more cameras in a camera system via camera interface(s) 1100. For example, in some embodiments, one or ore of any of cameras 104 and 106 can be coupled to device/system 1100 via camera interface(s) 1122.

In some embodiments, the processor 1102 may also be linked through the system interconnect 1106 to a storage device 1118 that can include a hard drive, a solid state drive (SSD), a magnetic drive, an optical drive, a portable drive, a flash drive, a Universal Serial Bus (USB) flash drive, an array of drives, and/or any other type of storage, including combinations thereof. In some embodiments, the storage device 1118 can include any suitable applications. In some embodiments, the storage device 1118 can include a basic input/output system (BIOS).

In some embodiments, the storage device 1118 can include any device or software, instructions, etc. that can be used (for example, by a processor such as processor 1102) to implement any of the functionality described herein, such as one or more camera calibration techniques. In some embodiments, for example, camera calibration 1120 is included in storage device 1118. In some embodiments, camera calibration 1120 can be used to provide any aspects of camera calibration as described herein and/or illustrated in the drawings. For example, in some embodiments, camera calibration 1120 can include instructions that can be processed to implement the camera calibration illustrated in and described in reference to FIG. 8, FIG. 9, and/or FIG. 10.

It is to be understood that the block diagram of FIG. 11 is not intended to indicate that the computing device 1100 is to include all of the components shown in FIG. 11. Rather, the computing device 1100 can include fewer and/or additional components not illustrated in FIG. 11 (e.g., additional memory components, embedded controllers, additional modules, additional network interfaces, etc.). Furthermore, any of the functionalities of the BIOS or of the camera calibration 1120 that can be included in storage device 1118 may be partially, or entirely, implemented in hardware and/or by the processor 1102. For example, the functionality may be implemented with an application specific integrated circuit, logic implemented in an embedded controller, or in logic implemented in the processor 1102, among others. In some embodiments, the functionalities of the BIOS and/or optimization 1120 can be implemented with logic, wherein the logic, as referred to herein, can include any suitable hardware (e.g., a processor, among others), software (e.g., an application, among others), firmware, or any suitable combination of hardware, software, and firmware.

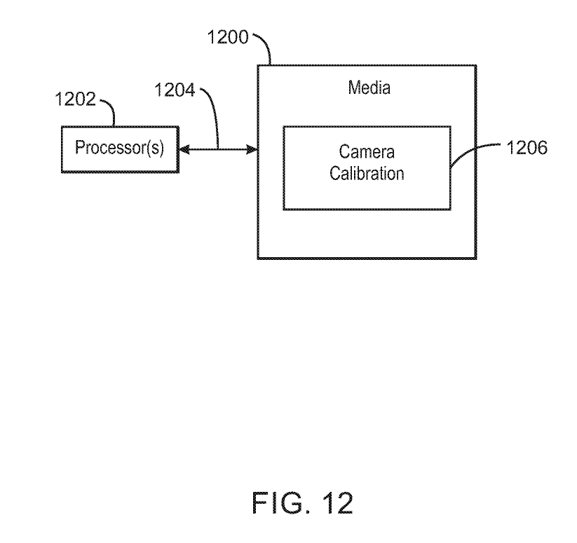

FIG. 12 is a block diagram of an example of one or more processor and one or more tangible, non-transitory computer readable media. The one or more tangible, non-transitory, computer-readable media 1200 may be accessed by a processor or processors 1202 over a computer interconnect 1204. Furthermore, the one or more tangible, non-transitory, computer-readable media 1200 may include code to direct the processor 1202 to perform operations as described herein. For example, in some embodiments, computer-readable media 1200 may include code to direct the processor to perform camera calibration 1206 according to some embodiments. In some embodiments, camera calibration 1206 can be used to provide any camera calibration techniques as described herein. For example, any of the features described anywhere herein, illustrated in, and/or described in reference to any of the figures can be included within camera calibration 1206. For example, in some embodiments, camera calibration 1206 can include instructions that can be processed to implement the camera calibration illustrated in and described in reference to FIG. 8, FIG. 9, and/or FIG. 10.

In some embodiments, processor 1202 is one or more processors. In some embodiments, processor 1202 can perform similarly to (and/or the same as) processor 1102 of FIG. 11, and/or can perform some or all of the same functions as can be performed by processor 1102.

Various components discussed in this specification may be implemented using software components. These software components may be stored on the one or more tangible, non-transitory, computer-readable media 1200, as indicated in FIG. 12. For example, software components including, for example, computer readable instructions implementing camera calibration 1206 may be included in one or more computer readable media 1200 according to some embodiments. Camera calibration 1206 may be adapted to direct the processor 1202 to perform one or more of any of the operations described in this specification and/or in reference to the drawings.

It is to be understood that any suitable number of software components may be included within the one or more tangible, non-transitory computer-readable media 1200. Furthermore, any number of additional software components not shown in FIG. 12 may be included within the one or more tangible, non-transitory, computer-readable media 1200, depending on the specific application.

It is noted that various calibration objects have been described herein. However, other objects can be used for camera calibration according to some embodiments. For example, three dimensional objects such as a dodecahedrons have been illustrated and described herein, but some embodiments do not require a dodecahedron. Some embodiments can be implemented, for example, with other objects other three dimensional objects, symmetrical objects, and/or non-symmetrical objects, etc. Additionally, objects with a different number of faces, sides, vertex points, etc. can be used other than described and/or illustrated herein according to some embodiments.

Reference in the specification to “one embodiment” or “an embodiment” or “some embodiments” of the disclosed subject matter means that a particular feature, structure, or characteristic described in connection with the embodiment is included in at least one embodiment of the disclosed subject matter. Thus, the phrase “in one embodiment” or “in some embodiments” may appear in various places throughout the specification, but the phrase may not necessarily refer to the same embodiment or embodiments.

Example 1 is a camera calibration system. The camera calibration system includes a plurality of cameras to be calibrated, one or more memory to store instructions, and one or more processor communicatively coupled to one or more of the plurality of cameras and to the one or more memory. When the processor is to execute the instructions, the processor is to determine a relationship between each of the plurality of cameras and a unique coordinate system, and to determine a positional relationship between all of the plurality of cameras based on the relationships between each of the cameras and the unique coordinate system.

Example 2 includes the camera calibration system of example 1, including or excluding optional features. In this example, the unique coordinate system is defined in advance based on a three dimensional model.

Example 3 includes the camera calibration system of any of examples 1 or 2, including or excluding optional features. In this example, when the processor is to execute the instructions, the processor is to determine the relationship between each camera and the unique coordinate system in response to an image of a three dimensional calibration object obtained by each camera.

Example 4 includes the camera calibration system of example 3, including or excluding optional features. In this example, the three dimensional calibration object is a polyhedron with a unique label on each face of the polyhedron.

Example 5 includes the camera calibration system of example 4, including or excluding optional features. In this example, when the processor is to execute the instructions, the processor is to detect two or more faces of the polyhedron using a unique label on each of the two or more faces of the polyhedron.

Example 6 includes the camera calibration system of any of examples 3-5, including or excluding optional features. In this example, the three dimensional calibration object is a dodecahedron.

Example 7 includes the camera calibration system of any of examples 1-6, including or excluding optional features. In this example, when the processor is to execute the instructions, for each camera, the processor is to identify a portion of a three dimensional calibration object in response to a camera image from the camera. When the processor is to execute the instructions, for each camera, the processor is to determine three dimensional coordinates in a coordinate system of a portion of the three dimensional calibration object, where the coordinate system of the portion of the three dimensional calibration object is oriented based on the identified portion of the three dimensional object. When the processor is to execute the instructions, for each camera, the processor is to determine transformation parameters based on the three dimensional coordinates in the coordinate system of the portion of the three dimensional calibration object. When the processor is to execute the instructions, for each camera, the processor is to convert a position of the three dimensional calibration object to the unique coordinate system based on the transformation parameters.

Example 8 includes the camera calibration system of example 7, including or excluding optional features. In this example, when the processor is to execute the instructions, the processor is to identify the portion of the three dimensional object based on a unique label on a portion of the three dimensional calibration object.

Example 9 includes the camera calibration system of any of examples 1-8, including or excluding optional features. In this example, when the processor is to execute the instructions, for each camera the processor is to obtain a point cloud image of a three dimensional calibration object. When the processor is to execute the instructions, for each camera the processor is to detect at least one portion of the three dimensional calibration object. When the processor is to execute the instructions, for each camera the processor is to select a portion of the three dimensional calibration object that includes a high image quality. When the processor is to execute the instructions, for each camera the processor is to calculate transformation parameters to transform camera coordinates of the selected portion to the unique coordinate system

Example 10 includes the camera calibration system of any of examples 1-9, including or excluding optional features. In this example, when the processor is to execute the instructions, for each camera the processor is to obtain a point cloud image of a three dimensional calibration object. When the processor is to execute the instructions, for each camera the processor is to detect a plurality of faces of the three dimensional calibration object. When the processor is to execute the instructions, for each camera the processor is to select two or more faces of the plurality of faces of the three dimensional calibration object. When the processor is to execute the instructions, for each camera the processor is to determine a common vertex of the two or more faces. When the processor is to execute the instructions, for each camera the processor is to calculate transformation parameters to transform coordinates of the common vertex to the unique coordinate system.

Example 11 is a camera calibration method for calibrating a plurality of cameras. The camera calibration system includes determining a relationship between each camera and a unique coordinate system, and determining a positional relationship between all of the plurality of cameras based on the relationships between each of the cameras and the unique coordinate system.

Example 12 includes the camera calibration method of example 11, including or excluding optional features. In this example, the unique coordinate system is defined in advance based on a three dimensional model.

Example 13 includes the camera calibration method of any of examples 11 or 12, including or excluding optional features. In this example, the relationship between each camera and the unique coordinate system is determined in response to an image of a three dimensional calibration object obtained by each camera.

Example 14 includes the camera calibration method of example 13, including or excluding optional features. In this example, the three dimensional calibration object is a polyhedron with a unique label on each face of the polyhedron.

Example 15 includes the camera calibration method of example 14, including or excluding optional features. In this example, two or more faces of the polyhedron are detected using a unique label on each of the two or more faces of the polyhedron.

Example 16 includes the camera calibration method of any of examples 13-15, including or excluding optional features. In this example, the three dimensional calibration object is a dodecahedron.

Example 17 includes the camera calibration method of any of examples 11-16, including or excluding optional features. In this example, the determining of the relationship between each camera and a unique coordinate system comprises identifying a portion of a three dimensional calibration object in response to a camera image, determining three dimensional coordinates in a coordinate system of a portion of the three dimensional calibration object, where the coordinate system of the portion of the three dimensional calibration object is oriented based on the identified portion of the three dimensional object, determining transformation parameters based on the three dimensional coordinates in the coordinate system of the portion of the three dimensional calibration object, and converting a position of the three dimensional calibration object to the unique coordinate system based on the transformation parameters.

Example 18 includes the camera calibration method of example 17, including or excluding optional features. In this example, the portion of the three dimensional object is identified based on a unique label on a portion of the three dimensional calibration object.

Example 19 includes the camera calibration method of any of examples 11-18, including or excluding optional features. In this example, for each camera, a point cloud image of a three dimensional calibration object is obtained, at least one portion of the three dimensional calibration object is detected, a portion of the three dimensional calibration object that includes a high image quality is selected, and transformation parameters are calculated to transform camera coordinates of the selected portion to the unique coordinate system.

Example 20 includes the camera calibration method of any of examples 11-19, including or excluding optional features. In this example, for each camera, a point cloud image of a three dimensional calibration object is obtained, a plurality of faces of the three dimensional calibration object are detected, two or more faces of the plurality of faces of the three dimensional calibration object are selected, a common vertex of the two or more faces are determined, and transformation parameters are calculated to transform coordinates of the common vertex to the unique coordinate system.

Example 21 is an apparatus to calibrate a plurality of cameras. The apparatus includes one or more controller to determine a relationship between each camera and a unique coordinate system, and to determine a positional relationship between all of the plurality of cameras based on the relationships between each of the cameras and the unique coordinate system.

Example 22 includes the apparatus of example 21, including or excluding optional features. In this example, the unique coordinate system is defined in advance based on a three dimensional model.

Example 23 includes the apparatus of any of examples 21 or 22, including or excluding optional features. In this example, the one or more controller is to determine the relationship between each camera and the unique coordinate system in response to an image of a three dimensional calibration object obtained by each camera.

Example 24 includes the apparatus of example 23, including or excluding optional features. In this example, the three dimensional calibration object is a polyhedron with a unique label on each face of the polyhedron.

Example 25 includes the apparatus of example 24, including or excluding optional features. In this example, the one or more controller is to detect two or more faces of the polyhedron using a unique label on the two or more faces of the polyhedron.

Example 26 includes the apparatus of any of examples 23-25, including or excluding optional features. In this example, the three dimensional calibration object is a dodecahedron.

Example 27 includes the apparatus of any of examples 21-26, including or excluding optional features. In this example, for each camera, the one or more controller it to identify a portion of a three dimensional calibration object in response to a camera image, to determine three dimensional coordinates in a coordinate system of a portion of the three dimensional calibration object, where the coordinate system of the portion of the three dimensional calibration object is oriented based on the identified portion of the three dimensional object, to determine transformation parameters based on the three dimensional coordinates in the coordinate system of the portion of the three dimensional calibration object, and to convert a position of the three dimensional calibration object to the unique coordinate system based on the transformation parameters.

Example 28 includes the apparatus of example 27, including or excluding optional features. In this example, the controller is to identify the portion of the three dimensional object based on a unique label on a portion of the three dimensional calibration object.

Example 29 includes the apparatus of any of examples 21-28, including or excluding optional features. In this example, for each camera the one or more controller is to obtain a point cloud image of a three dimensional calibration object, to detect at least one portion of the three dimensional calibration object, to select a portion of the three dimensional calibration object that includes a high image quality, and to calculate transformation parameters to transform camera coordinates of the selected portion to the unique coordinate system.

Example 30 includes the apparatus of any of examples 21-29, including or excluding optional features. In this example, for each camera the one or more controller is to obtain a point cloud image of a three dimensional calibration object, to detect a plurality of faces of the three dimensional calibration object, to select two or more faces of the plurality of faces of the three dimensional calibration object, to determine a common vertex of the two or more faces, and to calculate transformation parameters to transform coordinates of the common vertex to the unique coordinate system.

Example 31 is one or more tangible, non-transitory machine readable media including a plurality of instructions. In response to being executed on at least one processor, the instructions cause the at least one processor to determine a relationship between each camera and a unique coordinate system, and to determine a positional relationship between all of the plurality of cameras based on the relationships between each of the cameras and the unique coordinate system.

Example 32 includes the one or more tangible, non-transitory machine readable media of example 31, including or excluding optional features. In this example, the unique coordinate system is defined in advance based on a three dimensional model.

Example 33 includes the one or more tangible, non-transitory machine readable media of any of examples 31 or 32, including or excluding optional features. In this example, in response to being executed on at least one processor, the instructions cause the at least one processor to determine the relationship between each camera and the unique coordinate system in response to an image of a three dimensional calibration object obtained by each camera,

Example 34 includes the one or more tangible, non-transitory machine readable media of example 33, including or excluding optional features. In this example, the three dimensional calibration object is a polyhedron with a unique label on each face of the polyhedron.

Example 35 includes the one or more tangible, non-transitory machine readable media of example 34, including or excluding optional features. In this example, in response to being executed on at least one processor, the instructions cause the at least one processor to detect two or more faces of the polyhedron using the unique label on the two or more faces of the polyhedron.

Example 36 includes the one or more tangible, non-transitory machine readable media of any of examples 33-35, including or excluding optional features. In this example, the three dimensional calibration object is a dodecahedron.

Example 37 includes the one or more tangible, non-transitory machine readable media of any of examples 31-36, including or excluding optional features. In this example, in response to being executed on at least one processor, for each camera the instructions cause the at least one processor to identify a portion of a three dimensional calibration object in response to a camera image, to determine three dimensional coordinates in a coordinate system of a portion of the three dimensional calibration object, wherein the coordinate system of the portion of the three dimensional calibration object is oriented based on the identified portion of the three dimensional object, to determine transformation parameters based on the three dimensional coordinates in the coordinate system of the portion of the three dimensional calibration object, and to convert a position of the three dimensional calibration object to the unique coordinate system based on the transformation parameters.

Example 38 includes the one or more tangible, non-transitory machine readable media of any of example 37, including or excluding optional features. In this example, in response to being executed on at least one processor, the instructions cause the at least one processor to identify the portion of the three dimensional object based on a unique label on a portion of the three dimensional calibration object.

Example 39 includes the one or more tangible, non-transitory machine readable media of any of examples 31-38, including or excluding optional features. In this example, in response to being executed on at least one processor, for each camera the instructions cause the at least one processor to obtain a point cloud image of a three dimensional calibration object, to detect at least one portion of the three dimensional calibration object, to select a portion of the three dimensional calibration object that includes a high image quality, and to calculate transformation parameters to transform camera coordinates of the selected portion to the unique coordinate system.

Example 40 includes the one or more tangible, non-transitory machine readable media of any of examples 31-39, including or excluding optional features. In this example, in response to being executed on at least one processor, for each camera the instructions cause the at least one processor to obtain a point cloud image of a three dimensional calibration object, to detect a plurality of faces of the three dimensional calibration object, to select two or more faces of the plurality of faces of the three dimensional calibration object, to determine a common vertex of the two or more faces, and to calculate transformation parameters to transform coordinates of the common vertex to the unique coordinate system.

Example 41 is an apparatus to calibrate a plurality of cameras. The apparatus includes means for determining a relationship between each camera and a unique coordinate system, and means for determining a positional relationship between all of the plurality of cameras based on the relationships between each of the cameras and the unique coordinate system.

Example 42 includes the apparatus of example 41, including or excluding optional features. In this example, the unique coordinate system is defined in advance based on a three dimensional model.

Example 43 includes the apparatus of any of examples 41 or 42, including or excluding optional features. In this example, the apparatus includes means for determining the relationship between each camera and the unique coordinate system in response to an image of a three dimensional calibration object obtained by each camera.

Example 44 includes the apparatus of example 43, including or excluding optional features. In this example, the three dimensional calibration object is a polyhedron with a unique label on each face of the polyhedron.

Example 45 includes the apparatus of example 44, including or excluding optional features. In this example, the apparatus includes means for detecting two or more faces of the polyhedron using the unique label on the two or more faces of the polyhedron.

Example 46 includes the apparatus of any of examples 43-45, including or excluding optional features. In this example, the three dimensional calibration object is a dodecahedron.

Example 47 includes the apparatus of any of examples 41-46, including or excluding optional features. In this example, the apparatus includes for each camera, means for identifying a portion of a three dimensional calibration object in response to a camera image, means for determining three dimensional coordinates in a coordinate system of a portion of the three dimensional calibration object, where the coordinate system of the portion of the three dimensional calibration object is oriented based on the identified portion of the three dimensional object; means for determining transformation parameters based on the three dimensional coordinates in the coordinate system of the portion of the three dimensional calibration object, and means for converting a position of the three dimensional calibration object to the unique coordinate system based on the transformation parameters.

Example 48 includes the apparatus of example 47, including or excluding optional features. In this example, the apparatus includes means for identifying the portion of the three dimensional object based on a unique label on a portion of the three dimensional calibration object.

Example 49 includes the apparatus of any of examples 41-48, including or excluding optional features. In this example, the apparatus includes means for obtaining a point cloud image of a three dimensional calibration object, means for detecting at least one portion of the three dimensional calibration object, means for selecting a portion of the three dimensional calibration object that includes a high image quality, and means for calculating transformation parameters to transform camera coordinates of the selected portion to the unique coordinate system.

Example 50 includes the apparatus of any of examples 41-49, including or excluding optional features. In this example, the apparatus includes, for each camera, means for obtaining a point cloud image of a three dimensional calibration object, means for detecting a plurality of faces of the three dimensional calibration object, means for selecting two or more faces of the plurality of faces of the three dimensional calibration object, means for determining a common vertex of the two or more faces, and means for calculating transformation parameters to transform coordinates of the common vertex to the unique coordinate system.

Example 51 is an apparatus including means to perform a method as in any preceding example.

Example 52 is machine-readable storage including machine-readable instructions, when executed, to implement a method or realize an apparatus as in any preceding example.

Example 53 is a machine readable medium including code, when executed, to cause a machine to perform the method or realize the apparatus as in any preceding example.

Although example embodiments of the disclosed subject matter are described with reference to circuit diagrams, flow diagrams, block diagrams etc. in the drawings, persons of ordinary skill in the art will readily appreciate that many other ways of implementing the disclosed subject matter may alternatively be used. For example, the arrangements of the elements in the diagrams, and/or the order of execution of the blocks in the diagrams may be changed, and/or some of the circuit elements in circuit diagrams, and blocks in block/flow diagrams described may be changed, eliminated, or combined. Any elements as illustrated and/or described may be changed, eliminated, or combined.

In the preceding description, various aspects of the disclosed subject matter have been described. For purposes of explanation, specific numbers, systems and configurations were set forth in order to provide a thorough understanding of the subject matter. However, it is apparent to one skilled in the art having the benefit of this disclosure that the subject matter may be practiced without the specific details. In other instances, well-known features, components, or modules were omitted, simplified, combined, or split in order not to obscure the disclosed subject matter.

Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result.

Program code may represent hardware using a hardware description language or another functional description language which essentially provides a model of how designed hardware is expected to perform. Program code may be assembly or machine language or hardware-definition languages, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Program code may be stored in, for example, one or more volatile and/or non-volatile memory devices, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine-readable medium may include any tangible mechanism for storing, transmitting, or receiving information in a form readable by a machine, such as antennas, optical fibers, communication interfaces, etc. Program code may be transmitted in the form of packets, serial data, parallel data, etc., and may be used in a compressed or encrypted format.

Program code may be implemented in programs executing on programmable machines such as mobile or stationary computers, personal digital assistants, set top boxes, cellular telephones and pagers, and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments where tasks may be performed by remote processing devices that are linked through a communications network.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter. For example, in each illustrated embodiment and each described embodiment, it is to be understood that the diagrams of the figures and the description herein is not intended to indicate that the illustrated or described devices include all of the components shown in a particular figure or described in reference to a particular figure. In addition, each element may be implemented with logic, wherein the logic, as referred to herein, can include any suitable hardware (e.g., a processor, among others), software (e.g., an application, among others), firmware, or any suitable combination of hardware, software, and firmware, for example.

1-25. (canceled)

26. A camera calibration system comprising:
a plurality of cameras to be calibrated;
one or more memory to store instructions;
one or more processor communicatively coupled to one or more of the plurality of cameras and to the one or more memory, wherein when the processor is to execute the instructions, the processor is to:
determine a relationship between each of the plurality of cameras and a unique coordinate system; and
determine a positional relationship between all of the plurality of cameras based on the relationships between each of the cameras and the unique coordinate system.

27. The system of claim 26, wherein the unique coordinate system is defined in advance based on a three dimensional model.

28. The system of claim 26, wherein when the processor is to execute the instructions, the processor is to determine the relationship between each camera and the unique coordinate system in response to an image of a three dimensional calibration object obtained by each camera.

29. The system of claim 28, wherein the three dimensional calibration object comprises a polyhedron with a unique label on each face of the polyhedron.

30. The system of claim 29, wherein when the processor is to execute the instructions, the processor is to detect two or more faces of the polyhedron using the unique label on the two or more faces of the polyhedron.

31. The system of claim 28, wherein the three dimensional calibration object comprises a dodecahedron.

32. The system of claim 26, wherein when the processor is to execute the instructions, for each camera, the processor is to:
identify a portion of a three dimensional calibration object in response to a camera image from the camera;
determine three dimensional coordinates in a coordinate system of a portion of the three dimensional calibration object, wherein the coordinate system of the portion of the three dimensional calibration object is oriented based on the identified portion of the three dimensional object;
determine transformation parameters based on the three dimensional coordinates in the coordinate system of the portion of the three dimensional calibration object; and
convert a position of the three dimensional calibration object to the unique coordinate system based on the transformation parameters.

33. The system of claim 32, wherein when the processor is to execute the instructions, the processor is to identify the portion of the three dimensional object based on a unique label on a portion of the three dimensional calibration object.

34. The system of claim 26, wherein when the processor is to execute the instructions, for each camera the processor is to:
obtain a point cloud image of a three dimensional calibration object;
detect at least one portion of the three dimensional calibration object;
select a portion of the three dimensional calibration object that includes a high image quality; and
calculate transformation parameters to transform camera coordinates of the selected portion to the unique coordinate system.

35. The system of claim 26, wherein when the processor is to execute the instructions, for each camera the processor is to:
obtain a point cloud image of a three dimensional calibration object;
detect a plurality of faces of the three dimensional calibration object;
select two or more faces of the plurality of faces of the three dimensional calibration object;
determine a common vertex of the two or more faces; and
calculate transformation parameters to transform coordinates of the common vertex to the unique coordinate system.

36. A camera calibration method for calibrating a plurality of cameras, comprising:
determining a relationship between each camera and a unique coordinate system; and
determining a positional relationship between all of the plurality of cameras based on the relationships between each of the cameras and the unique coordinate system.

37. The camera calibration method of claim 36, wherein the determining of the relationship between each camera and a unique coordinate system comprises:
identifying a portion of a three dimensional calibration object in response to a camera image;
determining three dimensional coordinates in a coordinate system of a portion of the three dimensional calibration object, wherein the coordinate system of the portion of the three dimensional calibration object is oriented based on the identified portion of the three dimensional object;
determining transformation parameters based on the three dimensional coordinates in the coordinate system of the portion of the three dimensional calibration object; and
converting a position of the three dimensional calibration object to the unique coordinate system based on the transformation parameters.

38. The camera calibration method of claim 37, wherein the portion of the three dimensional object is identified based on a unique label on a portion of the three dimensional calibration object.

39. The camera calibration method of claim 36, comprising for each camera:
obtaining a point cloud image of a three dimensional calibration object;
detecting at least one portion of the three dimensional calibration object;
selecting a portion of the three dimensional calibration object that includes a high image quality; and
calculate transformation parameters to transform camera coordinates of the selected portion to the unique coordinate system.

40. The camera calibration method of claim 36, comprising for each camera:
obtaining a point cloud image of a three dimensional calibration object;
detecting a plurality of faces of the three dimensional calibration object;
selecting two or more faces of the plurality of faces of the three dimensional calibration object;
determining a common vertex of the two or more faces; and
calculate transformation parameters to transform coordinates of the common vertex to the unique coordinate system.

41. One or more tangible, non-transitory machine readable media comprising a plurality of instructions that, in response to being executed on at least one processor, cause the at least one processor to:
determine a relationship between each camera and a unique coordinate system; and
determine a positional relationship between all of the plurality of cameras based on the relationships between each of the cameras and the unique coordinate system.

42. The one or more tangible, non-transitory machine readable media of claim 41, comprising a plurality of instructions that, in response to being executed on at least one processor, for each camera cause the at least one processor to:
identify a portion of a three dimensional calibration object in response to a camera image;
determine three dimensional coordinates in a coordinate system of a portion of the three dimensional calibration object, wherein the coordinate system of the portion of the three dimensional calibration object is oriented based on the identified portion of the three dimensional object;
determine transformation parameters based on the three dimensional coordinates in the coordinate system of the portion of the three dimensional calibration object; and
convert a position of the three dimensional calibration object to the unique coordinate system based on the transformation parameters.

43. The one or more tangible, non-transitory machine readable media of claim 42, comprising a plurality of instructions that, in response to being executed on at least one processor, cause the at least one processor to identify the portion of the three dimensional object based on a unique label on a portion of the three dimensional calibration object.

44. The one or more tangible, non-transitory machine readable media of claim 41, comprising a plurality of instructions that, in response to being executed on at least one processor, for each camera cause the at least one processor to:
obtain a point cloud image of a three dimensional calibration object;
detect at least one portion of the three dimensional calibration object;
select a portion of the three dimensional calibration object that includes a high image quality; and
calculate transformation parameters to transform camera coordinates of the selected portion to the unique coordinate system.

45. The one or more tangible, non-transitory machine readable media of claim 41, comprising a plurality of instructions that, in response to being executed on at least one processor, for each camera cause the at least one processor to:
obtain a point cloud image of a three dimensional calibration object;
detect a plurality of faces of the three dimensional calibration object;
select two or more faces of the plurality of faces of the three dimensional calibration object;
determine a common vertex of the two or more faces; and
calculate transformation parameters to transform coordinates of the common vertex to the unique coordinate system.

46. An apparatus to calibrate a plurality of cameras, comprising:
one or more controller to:
determine a relationship between each camera and a unique coordinate system; and
determine a positional relationship between all of the plurality of cameras based on the relationships between each of the cameras and the unique coordinate system.

47. The apparatus of claim 46, for each camera the one or more controller to:
identify a portion of a three dimensional calibration object in response to a camera image;
determine three dimensional coordinates in a coordinate system of a portion of the three dimensional calibration object, wherein the coordinate system of the portion of the three dimensional calibration object is oriented based on the identified portion of the three dimensional object;
determine transformation parameters based on the three dimensional coordinates in the coordinate system of the portion of the three dimensional calibration object; and
convert a position of the three dimensional calibration object to the unique coordinate system based on the transformation parameters.

48. The apparatus of claim 47, the controller to identify the portion of the three dimensional object based on a unique label on a portion of the three dimensional calibration object.

49. The apparatus of claim 46, for each camera the one or more controller to:
obtain a point cloud image of a three dimensional calibration object;
detect at least one portion of the three dimensional calibration object;
select a portion of the three dimensional calibration object that includes a high image quality; and
calculate transformation parameters to transform camera coordinates of the selected portion to the unique coordinate system.

50. The apparatus of claim 46, for each camera the one or more controller to:
obtain a point cloud image of a three dimensional calibration object;
detect a plurality of faces of the three dimensional calibration object;
select two or more faces of the plurality of faces of the three dimensional calibration object;
determine a common vertex of the two or more faces; and
calculate transformation parameters to transform coordinates of the common vertex to the unique coordinate system.
